(19) United States
(12) Patent Application Publication
(10) Pub. No.: US 2009/0239025 A1
(43) Pub. Date: Sep. 24, 2009

(54) FLOCKED ARTICLES HAVING A WOVEN GRAPHIC DESIGN INSERT AND METHODS OF MAKING THE SAME

(75) Inventor: Louis Brown Abrams, Fort Collins, CO (US)

Correspondence Address: SHERIDAN ROSS PC, 1560 BROADWAY, SUITE 1200, DENVER, CO, 80202, US

(73) Assignee: High Voltage Graphics, Inc., Fort Collins, CO (US)

(21) Appl. No.: 12/397,946

(22) Filed: Mar. 4, 2009

Related U.S. Application Data
(60) Provisional application No. 61/033,717, filed on Mar. 4, 2008.
(60) Provisional application No. 61/036,403, filed on Mar. 13, 2008.
(60) Provisional application No. 61/037,982, filed on Mar. 19, 2008.
(60) Provisional application No. 61/073,691, filed on Jun. 18, 2008.

(51) Int. Cl. B32B 33/00; B32B 37/12

(52) U.S. Cl. 428/90; 156/230; 156/153

(57) ABSTRACT

The present invention is directed to an appliqué having a graphic design image woven into a textile weave a method of making the same.

### CROSS REFERENCE TO RELATED APPLICATIONS

The present application claims the benefit of U.S. Provisional Application Nos. 61/033,717 filed on Mar. 4, 2008, 61/036,403, filed on Mar. 13, 2008, 61/037,982 filed Mar. 19, 2008, and 61/073,691 filed Jun. 18, 2008 the entire contents of which are incorporated herein by reference in their entirety.

### FIELD OF THE INVENTION

This invention is directed generally to decorative articles and specifically to flocked articles having a woven graphic design insert and a method of making the same.

### BACKGROUND OF THE INVENTION

Appliqués, particularly dye-sublimation printed and flock appliqués, have grown in popularity in a wide variety of applications. The graphic design elements of the appliqué are important aspects of the appliqué. For example, U.S. patent applications Ser. Nos. 12/031,445, filed Feb. 14, 2008, and 11/874,146 filed Oct. 17, 2007, all to Abrams and each of which is incorporated herein by this reference, disclose appliqués having graphic designs and methods of making the same. U.S. patent application Ser. No. 12/031,445 discloses flocked appliqués having printed images, and U.S. patent application Ser. No. 11/874,146 discloses a method of adhesively joining inserts to a flocked appliqué.

Notwithstanding these patented graphic designs and applications, appliqués having greater attention grabbing value and artistic freedom are being sought. Such attention grabbing appliqués require more complex graphic design features.

For example, woven appliqué patches have been used for years but have been unattractive due to unattractive cut edges and itchy feel arising from the need to sew the appliqués onto a garment.

### SUMMARY OF THE INVENTION

This Inventor surprisingly and unexpectedly developed flocked articles and a process for making the same having a graphic design image woven into the weave of an insert. The appliqués of the present invention provide a woven textile look and feel desired with the convenience and comfort of a flock article, such as a flock transfer.

It is to be understood that the present invention includes a variety of different versions or embodiments, and this Summary is not meant to be limiting or all-inclusive. This Summary provides some general descriptions of some of the embodiments, but may also include some more specific descriptions of certain embodiments

One aspect of the disclosure is a textile design including: a woven textile having a graphic design image within a first side of the woven textile and an adhesive positioned on a second side of the woven textile. The first and second sides of the woven textile are in an opposing relationship.

The woven textile is selected from the group consisting essentially of: jacquard, brocade, bedford, damask, wandering weft, leno, needle lace, bobbin lace, embroidered netting, looped netting, knotted netting, open-work embroidery, knitting, macramé, sprang, wrap-faced, weft-faced, brocatelle, slit tapestry, dovetailed tapestry, interlocking tapestry, eccentric tapestry weaves, and combination weaves thereof.

The graphic design image of the woven textile includes one or more of a printed graphic design image, an image woven into the woven textile weave, and a combination thereof. The graphic design element is formed by weaving yarns and/or printing an image on a woven textile. The woven textile includes yarns having substantially the same and/or yarns having substantially differing colors.

In one preferred embodiment, the textile design further includes flock adhered to a portion of the first side of the woven textile. Preferably, the flock forms a flocked design including a plurality of flock fibers. More preferably, the plurality of flock fibers includes flock fibers of differing colors.

In one embodiment, the flock forms a flocked surface including a flock graphic design element. The flock graphic design element includes a flocked surface having a design shape element and/or a flocked surface including a plurality of colored flocked fibers.

In another embodiment, the woven textile and/or flock graphic design are separate and distinct design components.

In another embodiment, the textile design includes a flocked surface bonded to a portion of the second side of the woven textile by a second adhesive positioned between the flocked surface and the second side.

Another aspect of the disclosure is a method of making the textile design including the steps:

(a) providing a woven textile laminate;

(b) providing a flock transfer; and

(c) adhering the flock transfer to the woven textile laminate.

The woven textile laminate includes a woven textile having a graphic design element, first and second opposing surfaces, and an adhesive backing adhered to the first surface of the woven textile.

The flock transfer includes a release adhesive positioned between a carrier sheet and a plurality of flock fibers adhered to the carrier sheet by the release adhesive. The flock fibers have first and second ends. The second ends of the flock fibers are positioned adjacent to the carrier sheet.

In one embodiment, the method further includes applying a first adhesive to the first ends of the flock fibers and contacting the first adhesive with the second surface of the woven textile. The contacting step further includes registering the flock transfer and the second side of the woven textile laminate prior to or substantially simultaneous with the contacting of the first adhesive with the second side of the woven textile. In one configuration, the flock transfer further includes a void. The void and the second side of woven textile laminate are, respectively, registered prior to or substantially simultaneous with the contacting of the first adhesive with the second side.

The first adhesive is selected from the group consisting essentially of thermosetting adhesives, thermoplastic adhesives, and combinations thereof. Preferably, the first adhesive is at least one of a liquid, powder, web, self-supporting film, or solid adhesive. Preferred first adhesives are polyester or nylon adhesives.

In another embodiment, the method further includes the step of cutting the woven textile laminate into a desired shape prior to adhering the flock transfer to the woven textile laminate. The cutting step is conducted by one of laser, water-jet, or die cutting process. Preferably, the cutting step includes sealing and/or fussing woven textile edges formed by the cutting process.

In yet another embodiment, the method further includes the step of treating all or a portion of the second side of the woven textile lamination prior to contact with the first adhesive. The portion of the second side being treated is substantially in registration with the first adhesive area contacting the second side of the woven laminate. In one configuration, the treatment includes forming a plurality of apertures in second side of the woven textile laminate.

In another embodiment, the method further includes the step of adhering the adhesive backing to a substrate to form an article of commerce, such as an appliqué. The adhesive backing is positioned between the substrate and the woven textile.

In another embodiment, a second adhesive is positioned between the adhesive backing and the substrate to form an article of commerce, such as an appliqué. The adhesive backing is positioned between the second adhesive and the woven textile laminate. Appliqués secured to a substrate, such as clothing, with an adhesive can be less itchy and abrasive to the skin. Additionally, appliqués secured with an adhesive, typically, can have less, if at least mostly no, puckering around the appliqués perimeter.

Additional advantages of the present invention will become readily apparent from the following discussion, particularly when taken together with the accompanying drawings.

### BRIEF DESCRIPTION OF THE DRAWINGS

FIGS. 1A and 1B depict a textile design according to an embodiment;

FIG. 2 depicts another textile design according to another embodiment;

FIG. 3 depicts a process according to an embodiment;

FIG. 4 is side view of an embodiment;

FIG. 5 is a plane view of an embodiment;

FIGS. 6A-6D depict woven webs according to other embodiments;

FIG. 7 is another process according to another embodiment;

FIGS. 8A-8G depict textile designs according to another embodiment;

FIG. 9 is a plan view of a flock transfer according to an embodiment;

FIG. 10 is a plan view of another textile design according to another embodiment; and

FIGS. 11A and 11B depict textile designs according to other embodiments.

### DETAILED DESCRIPTION

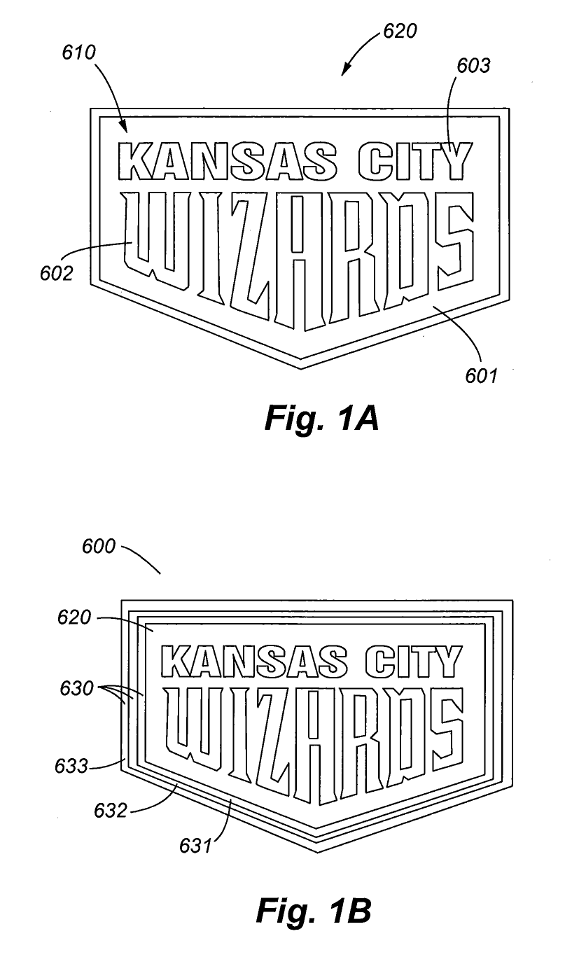

FIGS. 1A and 1B depict a textile design 600 according to an embodiment of the present invention. The textile design 600 includes a woven design insert 620 and flocked area 630 surrounding the woven design insert 620. The textile design 600 includes a first design component, the woven design insert 620, and a second design component, the flocked area 630. The first design component further includes a first insert design element represented in woven design insert 620 shape, a second insert design element represented by the text “Kansas City” in one type font and a first hue, a third insert design element represented by the text “Wizards” in a second more stylized font and a second hue, and a fourth insert design element represented by the woven background in a third hue. While the second design component further includes a first flock design element represented by a flocked shape and area, a second flock design element represented by flock band 631 having a first flock hue, a third flock design element represented by flock band 632 having a second flock hue, and a fourth flock design element represented by flock band 633 having a third flock hue. Preferably, the first and second design components are printed or formed by pre-colored fibers; the first design component by pre-colored yarn; and the second design component by multi-colored flock fibers.

As can be seen from FIG. 1, the first and second design components and their design elements are mutually registered (or aligned) to provide the desired appearance of the textile design 600. Proper registration requires not only that the insert 620 be cut to a proper or precise size and shape which is substantially about the same as the size and shape of the opening defined by the flocked area 630 but also that the cut lines on the insert 620 be positioned properly relative to the design elements of the first design component.

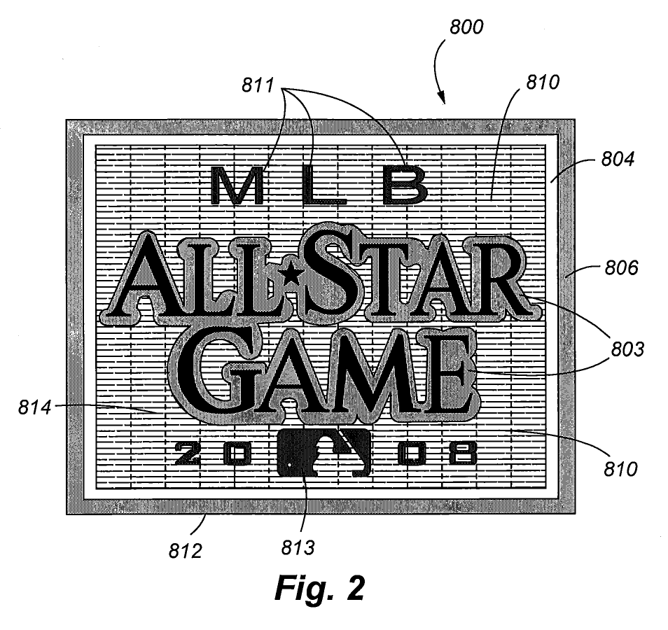

FIG. 2 shows another textile design 800 including a woven insert 810 and flocked areas 803, 804 and 806. The woven design insert 800 includes a first design element, (which is depicted as the logo “MLB” in a first hue 811), a second design element represented by the year 2008 (also in the first hue 812 with an image of batsman in a second hue 813 located between the two zeros of 2008), and a third design element represented by dark vertical weave lines against a white weave background 814. The first flock design element is represented by a first flocked area 803, a second by the second flocked area 804 and a third by a third flocked area 806. As can be seen from FIG. 2, the woven design insert 810 design elements (811, 812, 813, and 814) are registered relative to one another and to the flocked design elements (803, 804 and 806).

As can be seen from FIG. 2, the first flock design element 803 is deposited directly on top of the woven insert 810 while the second and third flock design elements 804 and 806 are positioned adjacent to or on top of the insert 810. In one configuration, the insert 810 is positioned in a void formed by the second and third flock design elements 804 and 806 and adhered to an adhesive backing of the second and third flock design elements 804. This technique of combining an incompatible insert with flock is further described in U.S. Pat. No. 5,207,851 and U.S. Pat. No. 5,346,746 the entire contents of which are incorporated herein by reference in their entirety. In another configuration, the second and third flock design elements 804 and 806 are also adhered to the top of the woven insert 810.

To form the various designs, a whole, multi-color design is selected and factored into distinct design components and/or elements. An artistic decision is made as to which of these elements will be reproduced in flock and which will be reproduced by a woven textile. The intent of the artistic decision is to enhance the artist quality and value of the design image through dimensionalization and separation of differently textured design elements.

The decision on whether a selected design feature is to be formed from flock, a woven design using pre-colored yarn, or a sublimation printed woven textile depends on many factors. First, the decision considers whether the design element or feature is in the foreground or background. Flock is typically used to create the illusion that a foreground feature is closer to the user than a background feature while woven textiles are used to create the illusion that a background feature is farther from the user than a foreground feature. Second, the decision considers the desired color intensity of the design element. In order of greatest color intensity, flock (whether pre-colored or sublimation printed after application) is first (because the viewer sees ends rather than sides of flock fibers), sublimation printed textiles are second, and woven textiles using pre-colored yarn are last. It is important to balance the color intensities of the flocked and woven textile (sublimation printed and/or woven textiles using pre-colored yarn) design elements. Third, the decision considers the desired luster of the design element. In order of greatest luster, sublimation printed textiles are first, woven textiles using pre-colored yarn are second, and flock is last. Fourth, the decision considers the fineness of detail required to be reproduced by the design element. In order of finest, smallest or highest resolution of detail that can be produced, sublimation printed woven textiles are first, woven textiles using pre-colored yarn are second, and flock is last. Finally, the decision considers the desired depth perception to be realized by the design. Flock is physically raised from the surface relative to the woven textile and therefore creates a perception not only of depth (i.e., of three-dimensions) but also of the flocked elements being closer to the viewer. The overall effect of combining design elements fabricated from flock and woven textiles is a multi-dimensional textile design having differing textures and topologies.

For printed design elements, the color intensity balance is influenced by the type of graphics file utilized in the printing process. Raster graphics files are preferred over vector files as the hue is more readily adjustable with raster graphic files.

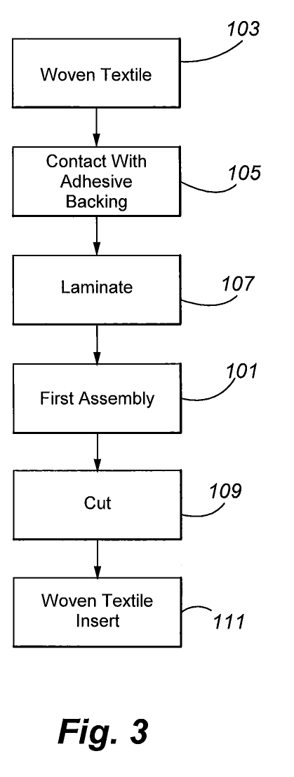

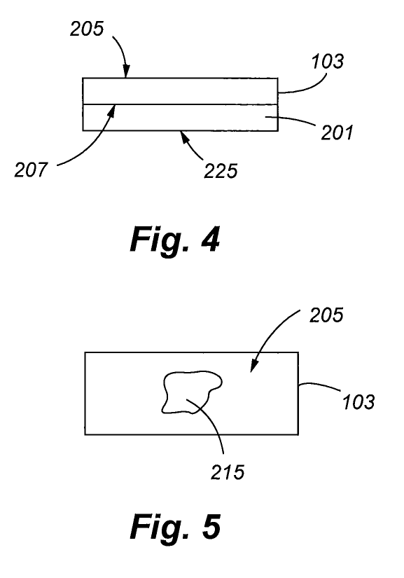

FIG. 3 depicts a method of preparing a woven textile insert 111. In step 105, an adhesive backing 201 (FIGS. 4 and 5) is contacted with a woven textile 103. The adhesive backing 201 can be any adhesive. Preferably, adhesive backing 201 is one of a thermosetting or a thermoplastic adhesive. A thermosetting adhesive generally refers to a polymer that solidifies or “sets” irreversibly when heated, and a thermoplastic adhesive generally refers to a polymer that softens when heated and returns to its original physical state when cooled to room temperature. The irreversible setting of a thermosetting adhesive is commonly achieved by cross-linking of at least most, if not all, of the cross-linking reactive entities contained in the adhesive polymer.

The adhesive film can include fine particles of polymers or copolymers, as well as one or more of plasticizer(s), stabilizer(s), curing agent(s) (such as an isocyanate), pigment(s), etc. Thermosetting adhesives can include curing agents, such as organic peroxides or sulfur. Examples of thermosetting adhesives include polyethylene, polyurethanes, polyester, polyamides, phenolics, alkyds, amino resins, polyesters, epoxides, and silicones. Examples of suitable thermosetting adhesives include, without limitation, polyesters, polyamides, nylons, and mixtures thereof, with polyester, nylon, or mixtures thereof being preferred. More preferred, the adhesive backing 210 is a dry film thermosetting adhesive, such as, a cast or extruded A-staged film. A-stage of a thermosetting adhesive means the early stage of the cross-linking reactions of the adhesive, wherein the adhesive is liquefied by heat and soluble in certain liquids. B-stage of a thermosetting adhesive means an intermediate stage in the reaction of a thermosetting adhesive where the adhesive may not entirely fuse or dissolve, that is, the adhesive softens when heated and swells when in contact with certain liquids. C-stage of a thermosetting adhesive means the final stage of the cross-linking reaction of a thermosetting adhesive, the adhesive is substantially insoluble and infusible, that is, the adhesive is substantially incapable of being softened or liquefied by heat. Although the adhesive can be applied as a liquid, thermosetting adhesives applied as a liquid or in a wet form can be wicked by textile fibers (or yarns) by the liquid surface tension. In a preferred configuration, the adhesive backing 210 is TSW-20™, a thermosetting adhesive, which can improve the heat-resistance and/or washing (laundry) resistance of the design. In one particular configuration, the washing resistance lasted at least about 100 wash cycles. That is, the backing adhesive 210 is resistant to deterioration during high temperature, high pH laundry processes.

The woven textile 103 is a woven textile having a graphic design image 215 woven into the weave. Non-limiting examples of a weaving process suitable for generating the graphic design image 215 within the weave of woven textile 103 are, without limitation: jacquard; brocade; bedford, damask; wandering weft; leno; needle or bobbin lace; embroidered, looped or knotted netting; open-work embroidery, knitting, macramé; sprang; wrap- or weft-faced; brocatelle; and slit, dovetailed, interlocking or eccentric tapestry weaves. In general, the preferred weaving process for producing the graphic design image 215 within the weave raises each warp (or weft) thread independent of the others and/or introduces a supplementary (or filler) yarn.

In a preferred embodiment, one or more of the yarns comprises at least some of the warp, weft, and/or supplemental yarns are dyed yarns (or threads). Preferably, the dyed yarns are resistant to high temperature, high pH industrial cleaning processes. In a more preferred embodiment, the yarns are solution, high temperature, or high function dyed.

Weaving the graphic design image 215 into the woven textile 103 using dyed yarns eliminates the need to print the graphic design image 215 on the textile, reducing and/or eliminating a step of printing an image on the textile. Additionally, having a graphic design image 215 within the weave of the woven textile 103 creates a unique artistic element to the woven graphic design image 215. The artistic quality and beauty of the woven graphic design image 215 generally surpasses the artistic quality and beauty of a similarly printed image. In can be appreciated that, the graphic design image 215, can be woven in a single hue, value of a single hue, or differing hues and/or values.

The woven textile 103 has first 205 and second 207 opposing surfaces. In one embodiment, the graphic design image 215 is at least contained within the weave of the first surface 205. In another embodiment, the design image is printed, such as by sublimiation printing techniques, onto the woven textile 103. The adhesive backing 201 is positioned adjacent to the second surface 207. Preferably, the adhesive backing 201 is adhered to the second surface 207.

In step 107, the adhesive backing 201 is laminated to the woven textile 103 to form first assembly 101, thereby securing the woven textile 103 to the adhesive backing 201. Heat and/or pressure are applied during the laminating process. The heat is sufficient to adhere the woven textile 103 to the adhesive backing 201. The heat at least softens the adhesive backing 201 to adhere the woven textile 103 to the adhesive backing 201. The temperature required to soften the adhesive backing 201 depends on the chemical properties of the adhesive. It can be appreciated that, when adhesive backing 201 is a thermosetting adhesive, the lamination step can A-, B- and/or C-stage the adhesive backing 201. A- and/or B-staging of adhesive backing 201 is generally preferred when the adhesive 201 is to be subsequently adhered to another material, though the adhesive backing 201 can be C-staged and later contacted with a hot melt or other thermoplastic adhesive to adhesively contact a desired substrate. The pressure is at least sufficient to substantially mechanically interlock the adhesive backing 201 with the woven textile 103.

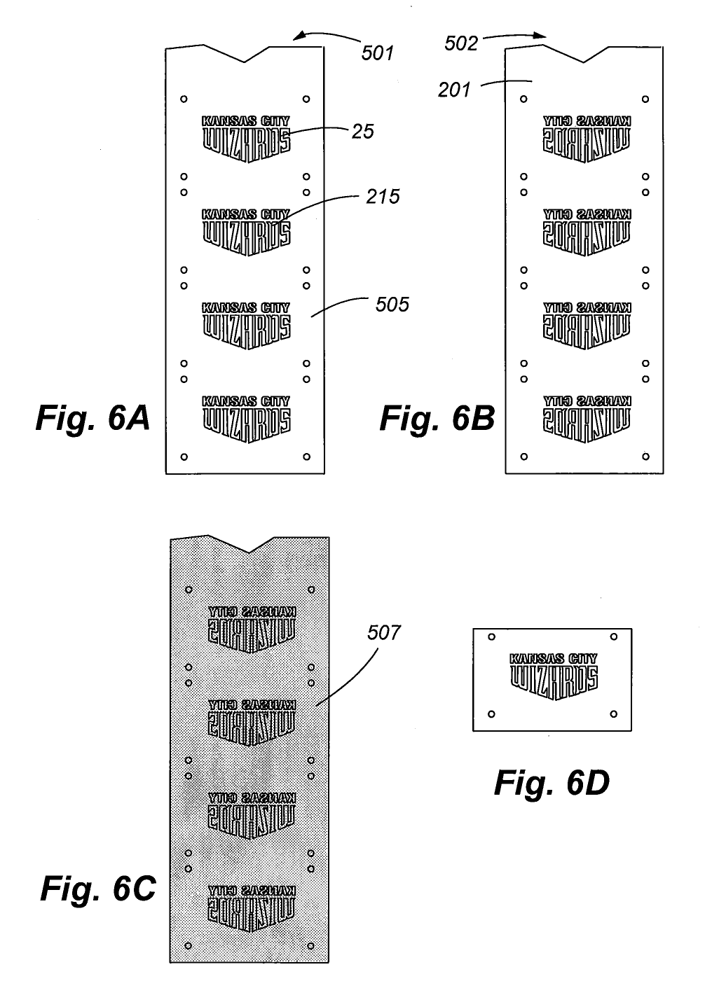

In one embodiment, the adhesive backing 201 is laminated to the woven web 501 (FIGS. 6A-6D) to form a laminated web 502. The adhesive backing 201 is contacted with the second surface 507 of the woven web 501 (the second surface 507 opposing the first surface 505 containing a plurality of the design image 215) before individual design images 215 are cut from the woven web 501. The woven web 501 is produced, for example, by an automated loom. In one embodiment, the woven textile 103 is provided directly from the loom.

The adhesive backing 210 adds stability to the first assembly 101 and keeps the first assembly 101 substantially flat and substantially dimensionally stable. Without the adhesive backing 201, the woven textile 103 substantially lacks sufficient stability and is difficult to keep flat to align the graphic design image 215 in registration for further processing, such as, cutting for an use as an insert. Manually aligning a woven textile lacking sufficient dimensional stability is difficult, consumes time, and adds cost. The backing adhesive 210 provides sufficient stability and/or rigidity to the first assembly 101, such that the assembly 101 is able to be aligned by a machine for further processing, such as, cutting for an insert. The woven textile 103 without the backing adhesive 201 substantially lacks stability for machine alignment. Additionally, the backing adhesive 210 maintains the woven textile 103 in a substantially flat, wrinkle-free condition after the appliqué containing the woven textile 103 is laundered.

An important aspect to consider is the thermally induced shrinkage of the woven textile 103. Normally, the woven textile 103 thermally shrinks, with the amount of shrinkage depending upon the length of time the woven textile 103 is maintained at a given temperature. At least two techniques can be used singly or collectively to compensate for thermal shrinkage. In one technique, the woven textile 103 is heated to at least the maximum temperature to be experienced during lamination, and, optionally, in later processing steps. The woven textile 103 is held at the selected temperature for a time sufficient for the woven material to thermally shrink. The heat is then removed, and the woven textile 103 cools. During cooling, the woven textile 103 weave relaxes. The thermally shrunk woven textile 103 is then subjected to the lamination process of applying the adhesive backing 210 thereto. The woven textile 103 can shrink by as much as 20% or more, depending on the applied temperature and the yarn composition and/or weave. In another technique, the pressure applied to the woven texture 103 during lamination is sufficiently high to inhibit substantially textile shrinkage. Preferably, the pressure applied during the lamination is at least about 10 psi, more preferably at least about 12 psi, and even more preferably ranges from about 12 to about 50 psi. Stated another way, the pressure applied by the platen to the woven textile 103 is preferably at least about 1 psi and even more preferably at least about 1.4 psi. Under these pressures, the dimensions of the woven textile 103 commonly shrink no more than about 5% and even more commonly no more than about 2.5%. After lamination, the adhesive backing 210 maintains substantially the dimensions of the woven textile 103 and design image 215.

In step 109, the first assembly 101 is cut to form a woven textile insert 111. In one configuration, the first assembly 101 is cut in registration with the graphic design image 215. The cutting process can be any cutting process, preferably a laser or die cutting process. The cutting process can also include an ablation process to improve adhesion of the woven textile 103 in subsequent processing. Particularly preferred laser cutting and/or ablation processes are disclosed in U.S. application Ser. No. 11/874,146 to Abrams which is incorporated herein with this reference.

Laser cutting is preferred. Laser cutting seals and/or fuses the edges, extending the useful area of the woven textile insert 111 to include the sealed and/or fused edges. In other words, the laser cutting fuses the yarns comprising the cut-edges of woven textile insert 111. The fused-edge yarns do not “pop-up” or fray, as do die-cut yarn edges. Die-cut edges typically have long loose yarns, such as “float” yarns on the surface which “pop up” and are easily and quickly frayed. The fused-edge yarns stay-in place, are more durable and more highly valued by consumers. It can be appreciated that, for some applications and designs frayed edges are preferred, such as, designs that have a worn, more casual, and/or more vogue appearance. The fused-edges of the woven textile insert 111 also allow higher processing line speeds. While not wanting to be bound by any theory, one or more fused-edge yarns and the adhesive melt during the laser cutting to form the fused edge. Typically, the appearance of the cut fused-edge has a “beaded-like” appearance. The laser power and speed of the cutting process commonly affect the degree that cut-edge yarns are fused. For example, low laser power and/or fast cutting speed decrease the degree to which the cut-edge is fused. Optimal fused-edges typically require a balancing of the laser power and line speed to properly fuse most, if not all, of the edge yarns and minimize, or eliminate, “pop-up” or frayed edge yarns.

In one implementation, cutting is performed by a cutting machine having an optical element to identify a selected reference point in each design image. The reference point can be identified optically, for example, using reflected laser light in a conventional laser light registration system, as known by those of skill in the art. Optical registration is preferred over using a guide side of the cut out insert (or a prior cut line) because woven materials lack sufficient dimensionality to use an edge for registration. Once the desired reference point is identified, the cutting element cuts out the design image using programmed logic to impart accurate registration and to precisely cut out the design image 215. In this manner, the design image 215 is cut to the desired size and shape. Also, the design elements of the design image 215 are registered relative to the cut lines. It can be appreciated that one of the artistic design elements is the relationship of the cut lines with the design image 215.

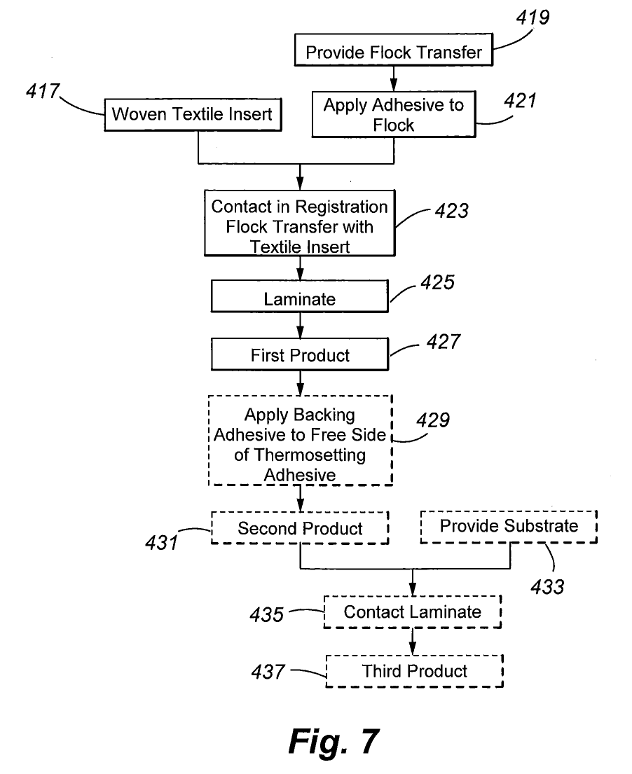

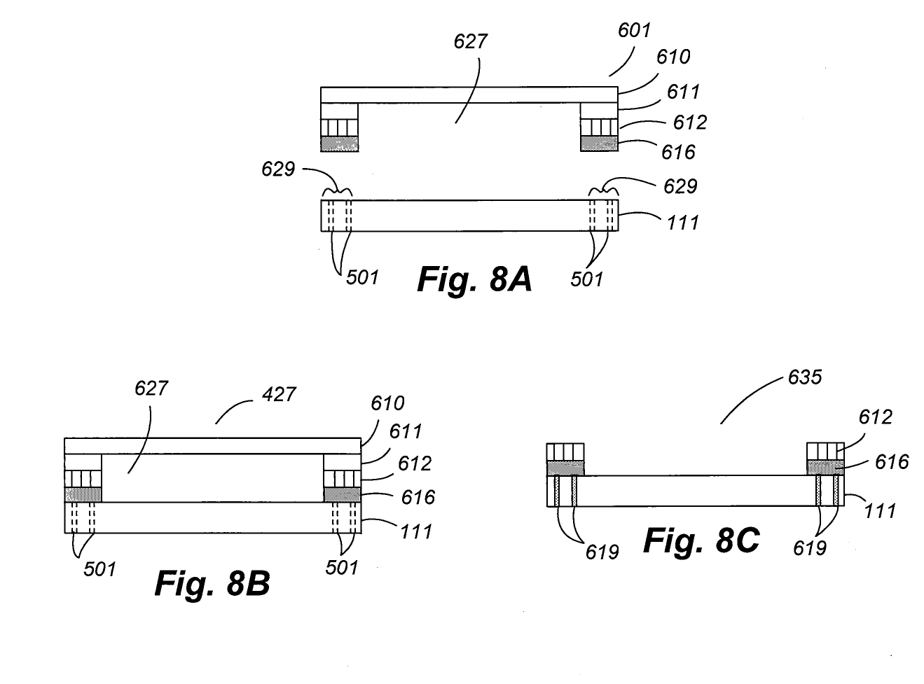

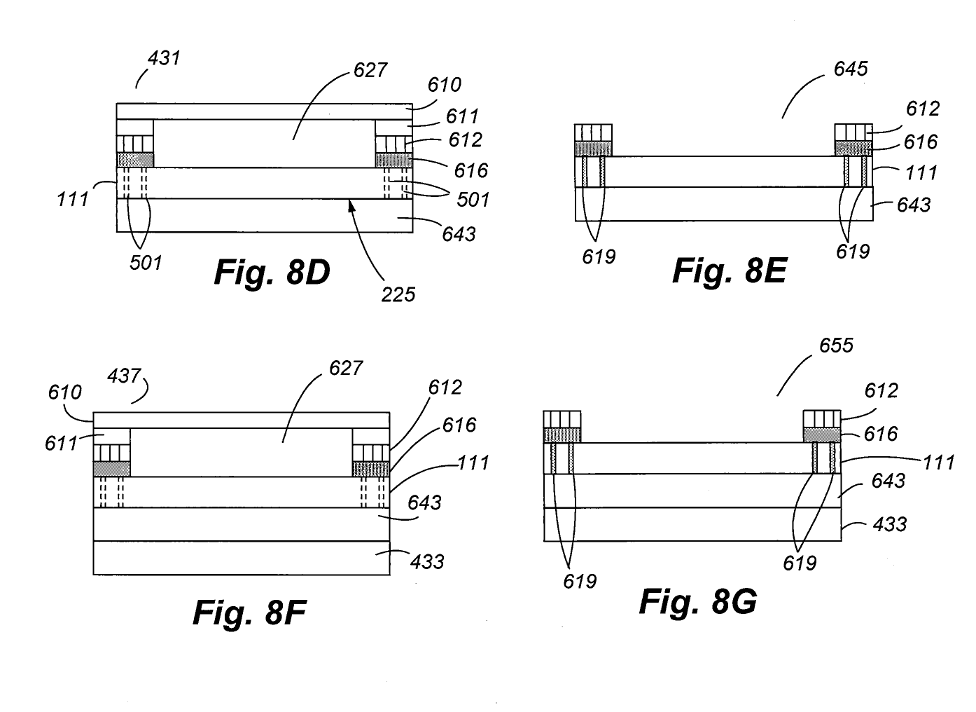

FIG. 7 depicts a process for adhering the woven textile insert 111 to a flocked transfer 601 to form the articles depicted in FIGS. 8A-8G.

The flock fibers can be any fibers. Particularly preferred are spun-dyed flock fibers having a color pigment within the flock fibers. Typically, the pigment is added to a polymer melt before and/or during the spinning of the flock fibers. Or stated another way, the pigment is contained and/or entrapped within the polymer comprising the flock fibers. The spun-dyed flock fibers are commonly known as color-fast flock fibers, that is, the dye is substantially retained within the flock fibers and is substantially resistant to fading, bleaching, or bleeding when laundered. Spun-dyed flock is especially resistant to high temperature, high pH industrial laundering processes. Another preferred flock dyeing process is high temperature and pressure autoclave dyeing. The autoclave dye process also substantially withstands industrial laundering.

In step 421, a first adhesive 616 is applied to free ends of at least most of the plurality of flock fibers 612. The flock fibers have first and second opposing ends. The first ends are adhered to the release sheet 610. The first adhesive 616 is applied to at least most of the second ends.

The first adhesive 616 can be any adhesive, preferably, a thermosetting or thermoplastic adhesive. The adhesive can be a liquid, powder, web, or solid adhesive. When the first adhesive 616 is a liquid, it can be sprayed, wet coated, or screen-printed on the free ends of the flock fibers 612. And, when the first adhesive 616 is a solid, it can be one of a powder, web, or dry self-supporting film, such as a continuous extruded film. Preferably, the first adhesive 616 is a polyester or nylon adhesive. Preferably, the first adhesive 616 is a powdered, thermoplastic polyester adhesive applied to at least most, if not all, of the free ends of the flock fibers 612. When the first adhesive 616 is a powder, it has a preferred powder size ranging from about 300 to about 400 microns. In one configuration, the first adhesive 616 is pre-cut, self-supporting adhesive film.

In step 423, the flocked transfer 601 with first adhesive 616 and the woven textile insert 111 are contacted in registration, such that, a contact area 629 having at least most, if not all, of the plurality of holes 501, is contacted in registration with the first adhesive 616. In one configuration, the woven textile insert 111 can be ablated, mechanically, chemically, or thermally treated to improve bonding adhesion to first adhesive 616. Additionally, the void 627 is in registration with at least most, if not all, of the graphic design image 215 of the woven textile insert 111.

In step 419, the flocked transfer 601 (FIG. 8A) is provided. The flocked transfer 601 is comprised of a release sheet 610, release adhesive 611, plurality of flock fibers 612, and void 627. It is appreciated that the void 627, embossed woven textile insert 111 or both are configured and/or sized, such that the woven textile insert 111 and void 627 substantially match to properly display the woven textile insert 111 when placed adjacent to the void 627. It can be further appreciated that, in one configuration, the void 627 and/or the graphic design image 215 substantially match in size and shape to properly display the woven textile insert 111 and/or graphic image 215 when placed adjacent to the void 627. In another configuration, the graphic design image 215 or insert 111 is slightly larger than the void 627. In this configuration, the width and height dimensions of the design image 215 are preferably at least about 2 mm, and even more preferably at least about 4 mm larger than the same respective dimensions of the void. The first ends of the flock fibers are adhered to the release sheet 610 by the release adhesive 611.

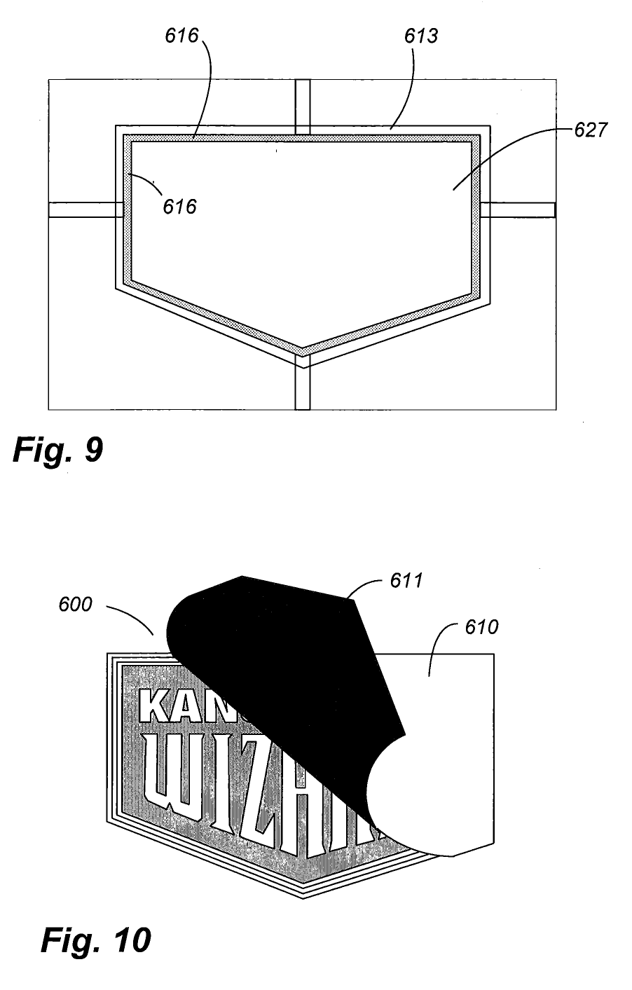

FIG. 9 depicts a flock transfer 419 having a void 627, with the first adhesive 616 applied to the flock fibers 612, and an optional flock border 613, which is free of the first adhesive 616. In one embodiment, the flock border slightly overlaps the woven insert 111.

In step 425, the first adhesive 616 is thermally bonded to the woven textile insert 111 to form first product 427 (FIG. 8B). During the lamination step 425, the first adhesive 616 is softened and/or partly liquefied and under the application of heat and pressure flows into the plurality of holes 501 filing the plurality of holes with the first adhesive 616 (shown in FIG. 8B as 619). It can be appreciated that, the woven textile 103 can be removed in selected areas of the contact area 629. While not wanting to be bound by theory, the plurality of holes 501 provide for enhanced adhesion by one or more of the following: mechanisms, mechanical interlocking of the first adhesive 616 within the plurality of holes 501 and chemical and physical adhesive bonding by the first adhesive 616 with the woven textile insert 111 by one or more of: chemisorption, dispersive interactions, electrostatic interactions, and diffusion.

In one configuration, the first adhesive 616 holding the transfer to the adjacent face of the insert 417 (FIGS. 8A-8C) provides a satisfactory bond (at least about 10 pounds measured by a lab peel test), primarily by securing a mechanical grip on the insert's surface. A molten holtmelt thermoplastic adhesive (e.g., LextraPrint™) or thermoplastic film (LextraMax™) must penetrate and surround the fibers of the insert textile, cool, and solidify, thereby providing a strong adhesion for product integrity. The enhanced adhesive penetration and strong adhesion is enabled by the plurality of holes 501.

As shown in FIG. 10, the release sheet 610 along with the associated release adhesive 611 can be peeled from the first product 427, to form a flocked product 635 (FIG. 8C) having a woven textile insert, which can, for example, be sewn onto a garment or other textile item.

In optional step 429, an adhesive backing 643 (FIG. 8D) is applied to surface 225 (FIG. 2) of adhesive 201. The adhesive backing 643 can be any adhesive, preferably, a liquid, web, or solid form of one of a thermosetting, thermoplastic, or multi-component adhesive thereof. Preferably, backing adhesive 643 is one of a solid web, dry self-supporting film (such as, as a continuous extruded film), or a multi-component adhesive film (such as, a bi-component adhesive film). In one embodiment, the adhesive 643 can be a polyester, nylon, or polyurethane adhesive. In another embodiment, the preferred backing adhesive 643 is a thermoplastic adhesive, preferably a soft rubber-like polyurethane, and more preferably a very soft, rubber-like polyurethane. Preferably, the backing adhesive 643 can be a non-woven web adhesive, more preferably a thermoplastic, non-woven web adhesive. Preferably, the web adhesive is one of a co-polyester, co-polyamide, polyolefin, or mixture thereof. The web adhesive can be contacted with surface 225. Or, a thermoplastic polyurethane adhesive layer can be interposed between surface 225 and the web adhesive. In such a case, the backing adhesive 643 comprises a bi-component adhesive of the thermoplastic polyurethane and web adhesives. While not wanting to be bound by any theory, the thermoplastic polyurethane provides an unexpected advantage of keeping the thermoplastic web adhesive from flowing through the thermosetting adhesive 201 in certain instances. In one configuration, the adhesive backing 643 is thermoplastic adhesive of about at most 1 mil thickness.

The surface 225 of the woven textile insert 111 (FIGS. 4 and 8A-8G) can be treated to further facilitate adhesion. The plurality of holes 501 formed during laser ablation (in step 315) can extend entirely through the woven textile insert 111 (that is, through woven textile 103 and adhesive 201) to facilitate adhesion of the backing adhesive 643 to the woven textile insert 11.

Returning to optional step 429, the backing adhesive 643 is contacted with the surface 225, and laminated with sufficient pressure and heat to cause the backing adhesive 643 to substantially flow. In can be appreciated that, the temperature and pressure required for the backing adhesive 643 to substantially flow depends on the chemical and physical properties of the backing adhesive 643. During lamination, the backing adhesive 643 can flow into the plurality of holes 501, the adhesive filling the plurality of holes 501 providing adhesion of the backing adhesive 643 to the thermosetting adhesive 201 of woven textile insert 111 to form a second product 431 (FIG. 8D).

In another embodiment, the backing adhesive 643 is a foamable or foaming thermosetting adhesive. In other words, the backing adhesive 643 includes one or more foaming agents selected such that, when step 435 is performed, the backing adhesive 643 is simultaneously foamed. The foamed adhesive will expand into voids within the surface 225, thereby providing a relatively level lower backing adhesive 643 surface.

The release sheet 610 along with the associated release adhesive 611 (if still attached) can be peeled from the second product 431 to form another flocked product 645 (FIG. 8E) having a woven textile insert, which can, for example, be applied to a garment, other textile item, or other non-textile surface by sufficient heat and pressure to adhere (and/or bind) the adhesive backing 643.

In step 435, a substrate 433 is provided and contacted with the second product 431. The substrate 433 can be substantially any hard or soft material that a thermoplastic adhesive can sufficiently adhere to. The substrate 433 can be, but is not limited, to any textile product, apparel (textile or non-textile), and/or consumer product (such as, automotive, electronic, computer, soft or hard goods, etc.). After and/or substantially simultaneous with contacting the second product 645 with the substrate 433, heat and pressure substantially sufficient to activate the adhesive backing 643 are applied to adhere the second product 645 to the substrate 433 to form a third product 437 (FIG. 8F). After adhering the second product 645 to substrate 433, the release sheet 610 and release adhesive 611 (if still attached) can be removed to form yet another flocked product 655 (FIG. 8G).

In one embodiment, steps 423 and 425 can be performed substantially simultaneously to form the first product 427. Similarly, in another embodiment, steps 423, 425, and 429 can be performed substantially simultaneously to form the second product 431. And, in yet another embodiment, steps 423, 425, 429, 433, and 435 can be performed substantially simultaneously to form the third product 437. It can be further appreciated, that steps 429, 433, and 435 can be substantially preformed when the first product 427 is provided to form the third product 437.

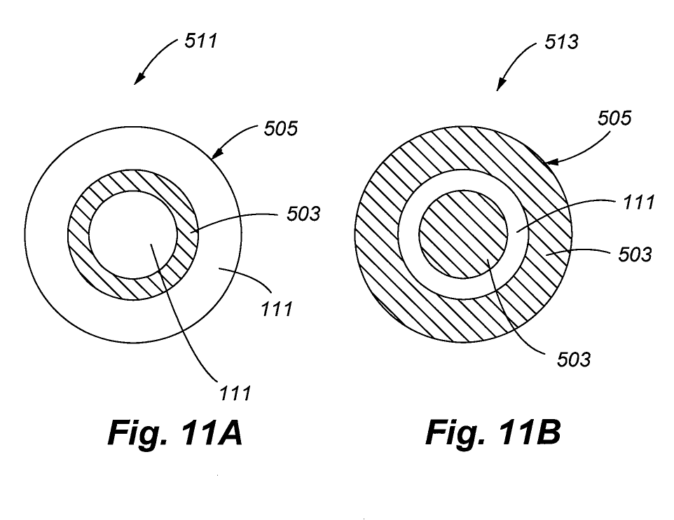

FIG. 11A depicts an embodiment having a woven textile insert 111 insert, a flock surface 503 surrounding and/or defining the shape of the woven textile insert 111, and an outer-most perimeter 505 comprises a portion of the woven textile insert 111. The outer-most perimeter 505 edge of the woven textile insert 111 comprises a heat sealed and/or fused edge. The heat sealed edge being sufficiently fused to substantially prevent any fraying and/or unraveling of the woven textile 103 weave.

FIG. 11B depicts another embodiment having a flock surface 503 surrounding a woven textile insert 111. It can further be appreciated that, while FIGS. 8A-8G depict the flock fibers 612 applied to the edge and/or perimeter of the woven textile insert 111, the flock fibers 612 can be applied anywhere on woven textile insert 111. It can be further appreciated that FIGS. 5A and 5B separately and independently depicts each of first 425, second 431, and third 437 products.

As will be appreciated, the flock transfer can also be manufactured as taught by U.S. Pat. Nos. 5,207,851 and 5,346,746, which are incorporated herein by this reference.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A textile design, comprising:
(a) a woven textile having at least one graphic design image on a first side of the woven textile;
(b) an adhesive positioned on a second side of the woven textile, the first and second sides being in an opposing relationship; and
(c) flock bonded to the first side of the woven textile.

2. The design of claim 1, wherein the graphic design image is formed by a plurality of differently colored threads woven together and wherein the complete exteriors of the threads are colored.

3. The design of claim 2, wherein the at least one graphic design image is a printed graphic design image and wherein only portions of the exteriors of the threads are colored.

4. The design of claim 2, wherein a composite design is formed by the graphic design image and flock such that first design elements are formed by the composite design image and second design elements are formed by the flock and wherein the first and second design elements together form the composite design image.

5. The design of claim 4, wherein the flock is adhered to the first side of the woven textile, wherein a second adhesive is positioned between the flock and the first side of the woven textile, and wherein, where the flock contacts the woven textile, the woven textile comprises at least one of holes and roughened features to increase a bonding strength of the second adhesive to the woven textile.

6. A textile design, comprising:
(a) a woven textile having first and second opposing sides and a first graphic design element on the first side;
(b) a first adhesive positioned on the first side; and
(c) a flocked surface bonded to the adhesive on the first side, wherein the flocked surface comprises a second graphic design element.

7. The textile of claim 6, wherein the first and second graphic design elements are separate and distinct design elements, wherein the first graphic design element comprises one or more of: (i) a woven design contained within the woven textile weave and (ii) a design printed on second side of the woven textile.

8. The textile of claim 7, wherein (i) is true and wherein the woven graphic design element is formed by weaving pre-colored yarns of different colors and/or hues.

9. The textile of claim 8, wherein the second graphic design element comprises at least one of: a flocked surface in the shape of a graphic design element and a flocked surface comprising a plurality of flocked fibers having differing hues and wherein a contact area of the woven textile has at least one of holes and roughened areas to enhance adhesion of the first adhesive to the woven textile.

10. The textile of claim 9, wherein the woven textile has a weave selected from the group consisting essentially of: jacquard, brocade, bedford, damask, wandering weft, leno, needle lace, bobbin lace, embroidered netting, looped netting, knotted netting, open-work embroidery, knitting, macramé, sprang, wrap-faced, weft-faced, brocatelle, slit tapestry, dovetailed tapestry, interlocking tapestry, eccentric tapestry weaves, and combination weaves thereof.

11. A method of making a textile design, comprising:
(a) providing a woven textile having:
i) first and second opposing surfaces; and
ii) at least one graphic design image;
(b) providing a flock transfer, wherein the flock transfer comprises a release adhesive positioned between a carrier sheet and plurality of flock fibers having first and second ends and wherein the plurality of flocked fibers are adhered to the carrier sheet by the release adhesive;
(c) applying an adhesive to the first ends, wherein the second ends are positioned adjacent to the carrier sheet;
(d) contacting the adhesive with the first side;
(e) applying at least one of heat and pressure to adhere the flock transfer to the first side of the woven textile.

12. The method of claim 11, further comprising:
(f) adhering an adhesive backing to the second surface to form a laminate

13. The method of claim 11, wherein the at least one graphic design image is at least one of a sublimation dye printed image, a woven image contained within woven textile weave, and a combination thereof.

14. The method of claim 11, wherein the woven image woven is formed by weaving pre-colored yarns selected from the yarns having substantially differing colors and/or hues.

15. The method of claim 11, wherein the weave of the woven textile is selected from the group consisting essentially of: jacquard, brocade, bedford, damask, wandering weft, leno, needle lace, bobbin lace, embroidered netting, looped netting, knotted netting, open-work embroidery, knitting, macramé, sprang, wrap-faced, weft-faced, brocatelle, slit tapestry, dovetailed tapestry, interlocking tapestry, eccentric tapestry weaves, and combination weaves thereof.

16. The method of claim 11, wherein after step (b) but before step (c) further comprising:
(g) cutting the laminate into a desired shape.

17. The method of claim 16, wherein the cutting step (g) is conducted by one of: laser, water-jet, or die cutting process.

18. The method of claim 16, wherein the cutting step (c) is conducted by a laser cutting process and wherein the cutting step (c) further comprises sealing and/or fusing woven textile edges formed by the cutting process.

19. The method of claim 11, wherein the adhesive contacts a contact area of the woven textile and further comprising:
(g) prior to step (d), roughening a contact area of the woven textile to enhance adhesion of the adhesive to the woven textile and wherein the plurality of flock fibers comprise flock fibers having differing hues.

20. The method of claim 11, wherein the contacting step (e) further comprises:
registering the flock transfer and the second side prior to or substantially simultaneous with the contacting of the adhesive with the first side, wherein the adhesive is selected from the group consisting essentially of thermosetting adhesives, thermoplastic adhesives, and combinations thereof.

21. The method of claim 11, wherein the flock transfer further comprises a void surrounded substantially by flock fibers and wherein the contacting step (e) further comprises:
registering the void and the second side prior to or substantially simultaneous with the contacting of the adhesive with the first side, wherein the adhesive is at least one of a liquid, powder, web, self-supporting film, or solid adhesive, and wherein the adhesive is selected from the group consisting essentially of thermosetting adhesives, thermoplastic adhesives, and combinations thereof.

22. The method of claim 19, wherein before step (g) further comprising:
(h) treating at least a portion of the second side, wherein the portion of the second side being treated is substantially in registration with the adhesive area contacting the second side, wherein the treatment step (h) comprises forming a plurality of apertures in second side, wherein the portion of the second side being treated is substantially in registration with the adhesive area contacting the second side.
